(19) United States
(12) Patent Application Publication
(10) Pub. No.: US 2003/0179931 A1
(43) Pub. Date: Sep. 25, 2003

(54) Region-based image recognition method

(76) Inventor: Hung-Ming Sun, Yunlin (TW)

Correspondence Address: BIRCH STEWART KOLASCH & BIRCH, PO BOX 747, FALLS CHURCH, VA, 22040-0747, US

(21) Appl. No.: 10/231,110

(22) Filed: Aug. 30, 2002

(30) Foreign Application Priority Data
Mar. 19, 2002 (TW) 91105188

(51) Int. Cl. G06K 9/46; G06K 9/62; G06K 9/34

(52) U.S. Cl. 382/190; 382/224; 382/173

(57) ABSTRACT

A region-based image recognition method. First, an input image is segmented into a plurality of regions, and the color feature, texture feature, shape feature, position feature and size feature of each region are extracted. Then, the regions are classified by inputting its features into a classifier. The classifier can be a set of decision rules, a neural network model, or a Bayesian classifier.

### BACKGROUND OF THE INVENTION

1. Field of the Invention

The present invention relates to an image recognition method, and particularly to a region-based image recognition method.

2. Description of the Related Art

Extraction of specific regions is a common preprocessing step for image recognition. For example, in face searching, face recognition and tracking, gesture recognition, and sexual image filtering, extraction of skin regions generally poses as a first stage before object recognition.

For skin detection, traditional methods examine every pixel independently and pick up the pixels whose color looks like skin. Specifically, a mathematical model for describing skin color is provided. The mathematical model can be a set of decision rules, or a trainable classification algorithm, e.g., Neural Networks. Then, a pixel is recognized as skin if its color is classified to be skin-like by the mathematical model; otherwise, the pixel is recognized as not skin.

FIGS. 1a and 1b show two examples for extraction of skin regions. After applying a conventional method, the results are FIGS. 2a and 2b, respectively, where the gray areas represent the skin regions extracted. In the conventional method, a pixel is determined to be skin or not based only on its color without considering the relationship between pixels. Consequently, the floor in FIG. 1a and the background in FIG. 1b are mistakenly classified as skin regions since their color is similar to skin.

U.S. Pat. No. 6,115,495 discloses an image recognition method based on color features. First, an input image is divided into a plurality of regions. Then, the color features of each region are extracted and matched to a database to sift the regions that reveal the specific color features. In the method, a region is classified according to its color features. When applied to skin extraction, the regions that reveal skin-like color, e.g., wood, will be erroneously regarded as skin.

### SUMMARY OF THE INVENTION

It is therefore an object of the present invention to provide a region-based image recognition method that utilizes various kinds of features, such as color, texture, shape, position and size.

To achieve the above object, a region-based image recognition method according to one embodiment of the present invention is provided. First, an input image is segmented into a plurality of regions, and various features of each region are extracted. Then, each region is classified by examining its features using a set of predefined rules.

According to another aspect of the present invention, an input image is first segmented into a plurality of regions, and various features of each region are extracted. Then, each region is classified to be skin or not according to a weighted feature difference. Many other algorithms can also be chosen to implement the classifier such as Neural Network Models and Bayesian classifiers. The feature types used include color, texture, shape, position, and size.

### BRIEF DESCRIPTION OF THE DRAWINGS

The aforementioned objects, features, and advantages of this invention will become apparent by referring to the following detailed description of the preferred embodiment with reference to the accompanying drawings, wherein:

FIG. 1a shows an example for skin region extraction;

FIG. 1b shows another example for skin region extraction;

FIG. 2a shows the result of FIG. 1a after applying a conventional method;

FIG. 2b shows the result of FIG. 1b after applying a conventional method;

FIG. 3 is a flow chart illustrating the operation of the region-based image recognition method according to the embodiment of the present invention;

FIG. 4a shows the result of FIG. 1a after applying the region-based image recognition method according to the present embodiment; and

FIG. 4b shows the result of FIG. 1b after applying the region-based image recognition method according to the present embodiment.

### DETAILED DESCRIPTION OF THE INVENTION

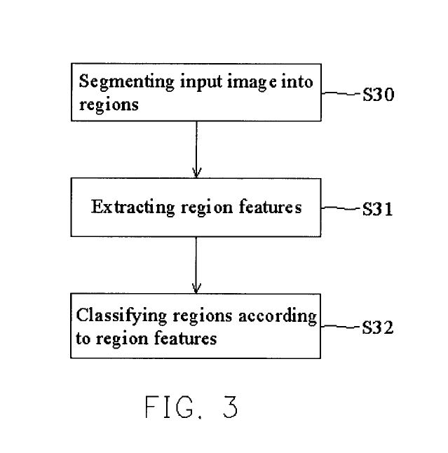

FIG. 3 is a flow chart illustrating the operation of the region-based image recognition method according to the embodiment of the present invention.

First, in step S30, an input image is segmented into a plurality of regions. The image can be segmented by using edge detection, color quantization, region splitting and merging, or region growing.

Then, in step S31, various features of each region are extracted. The region features may include color, texture, shape, position, and size. Finally, in step S32, each region is classified by examining its features using a set of predefined rules.

According to another aspect, an input image is first segmented into a plurality of regions, and various features of each region are extracted. Then, each region is classified to be skin or not according to a weighted feature difference. For example, the region is classified as skin if the weighted feature difference is less than a predetermined threshold value for skin.

It should be noted that the classification can also be achieved by set of decision rules or a trainable mathematical model, such as neural networks or a Bayesian classifier.

A set of decision rules is discussed below for identification of skin regions.

1. Color Feature

First, a skin color model is provided for identification of skin pixels. For a region, the ration R of the skin pixels to all of the pixels is calculated. The rule for checking the color feature is that if R is smaller than a predefined threshold value, the region is not skin. Those regions passing the test will enter the next stage.

2. Shape Feature

A shape feature named eccentricity is defined as below. If c is the gravity center of a region and n is the number of pixels in the region, the radius r of the region is

$$r = \sqrt{\frac{n}{π}} .$$

The eccentricity e of the region is computed by

$$e = {\sum }_{p} S ( p , c ) ,$$

where p is the pixels in the region and

$$S ( p , c ) = \{ \begin{matrix}dist ( p , c ) - r , & if dist ( p , c ) > r \\ 0 , & otherwise\end{matrix} .$$

To avoid the eccentricity e from changing due to different region size, the eccentricity e must be normalized by:

$${e}^{′} = {( \frac{R}{r} )}^{3} e ,$$

where R is a predetermined standard radius.

The rule for checking the shape feature is that if e′ is larger than a predetermined threshold value, the region is not skin. Those regions passing the test will enter the next stage.

3. Texture Feature

Many things are of skin-like color, e.g., wood, sheep, etc. However, some kind of texture appears on their surface while human skin does not. To catch such difference, a texture value T is defined as the ratio of edge pixels to all of the pixels in a region. The edge pixels can be found by applying any edge detection method to the region. The rule for checking the texture feature is that if T is larger than a pre-selected threshold value, the region is not skin. Those regions passing the test will enter the next check.

4. Position Feature

A common fact in photos is that the target object resides around the center. If the subject of an image is a person, the skin regions should be near the image center. Hence, the rule for checking the position feature can be that if the region touches more than a predetermined percentage of the image border, the region is not skin. The region passing the test will enter the next check.

5. Size Feature

The size feature is used to filter the fractional regions, which are considered redundant, yielded by the segmentation preprocess. The rule for checking the size feature is that if the size of a region is smaller than a predetermined threshold value, the region is not skin. The regions that pass all the checking rules are regarded as skin.

It should be noted that the aforementioned rules are examples defined for skin recognition. These rules could be changed or modified according to different image recognition applications.

The features described above can also be input into a trained classifier, e.g., Neural Network Models, for recognition instead of using the decision rules.

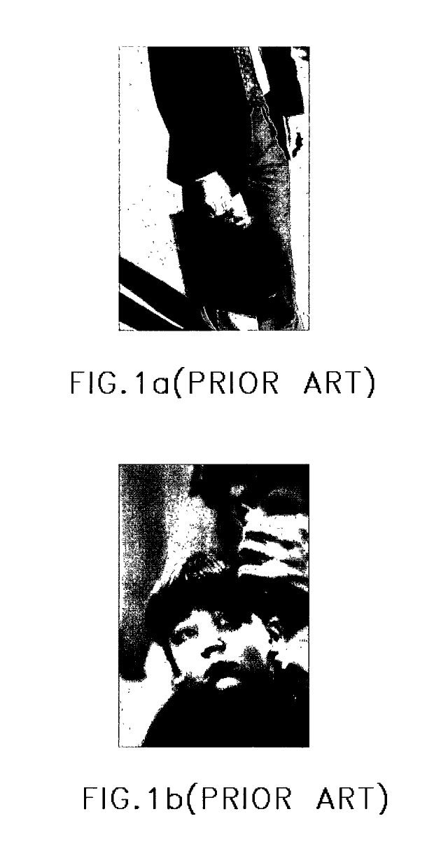

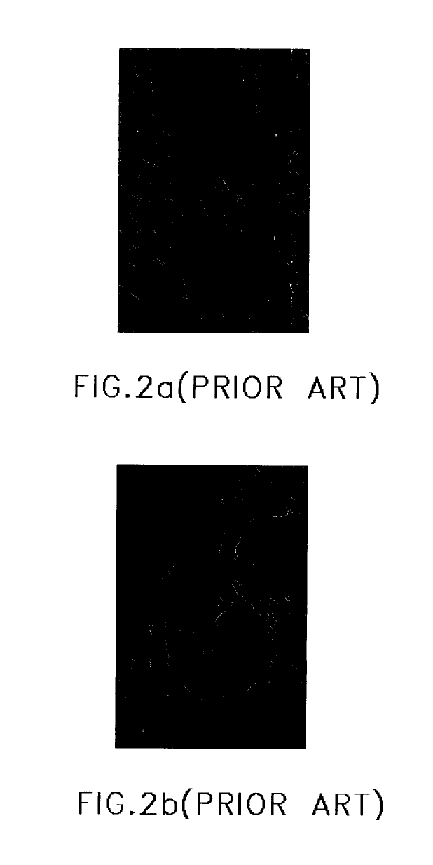

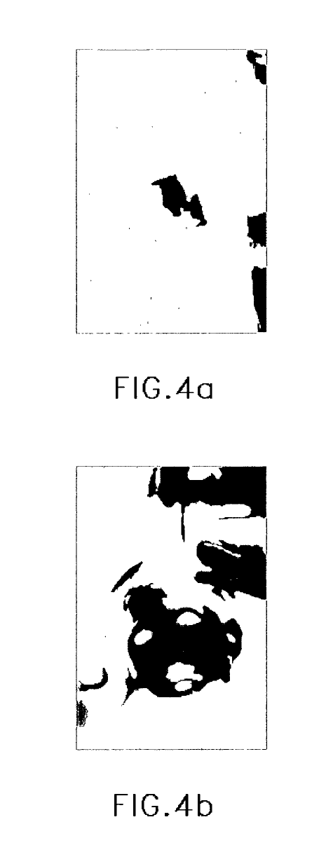

FIGS. 4a and 4b show the results of FIG. 1a and 1b after applying the region-based image recognition method according to the embodiment of the present invention. Compared with FIGS. 2a and 2b, fewer background areas are recognized erroneously as skin. Hence, the region-based image recognition method incorporating with the various features, such as color, texture, shape, position and size, is capable of improving the accuracy of image recognition.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A region-based image recognition method, comprising the steps of:
segmenting an input image into a plurality of regions;
extracting a feature of each region; and
classifying a region by inputting its feature into a classifier.

2. The method as claimed in claim 1 wherein the feature is color.

3. The method as claimed in claim 1 wherein the feature is texture.

4. The method as claimed in claim 1 wherein the feature is shape.

5. The method as claimed in claim 1 wherein the feature is position.

6. The method as claimed in claim 1 wherein the feature is size.

7. The method as claimed in claim 1 wherein the classifier is a neural network algorithm.

8. The method as claimed in claim 1 wherein the classifier is a Bayesian classifier.

9. The method as claimed in claim 1 wherein the classifier is a set of decision rules.

10. The method as claimed in claim 1 wherein the region is classified as skin or not.

11. A region-based image recognition method, comprising the steps of:
segmenting an input image into a plurality of regions;
extracting the color feature, texture feature, shape feature, position feature and size feature of each region; and
classifying a region as skin or not by inputting its features into a classifier.

12. The method as claimed in claim 11 wherein the classifier is a neural network algorithm.

13. The method as claimed in claim 11 wherein the classifier is a Bayesian classifier.

14. The method as claimed in claim 11 wherein the classifier is a set of decision rules.
